(19) United States
(12) Patent Application Publication
(10) Pub. No.: US 2013/0162752 A1
(43) Pub. Date: Jun. 27, 2013

(54) Audio and Video Teleconferencing Using Voiceprints and Face Prints

(71) Applicants: William S. Herz, Hayward, CA (US); Carl Kittredge Wakeland, Scotts Valley, CA (US)

(72) Inventors: William S. Herz, Hayward, CA (US); Carl Kittredge Wakeland, Scotts Valley, CA (US)

(73) Assignee: Advanced Micro Devices, Inc., Sunnyvale, CA (US)

(21) Appl. No.: 13/334,238

(22) Filed: Dec. 22, 2011

(51) Int. Cl. G06K 9/62; H04N 7/15

(52) U.S. Cl. 348/14.08; 382/118; 348/E07.083

(57) ABSTRACT

Provided is a device including one or more processors, wherein the one or more processors are configured to periodically match an image of an individual with one of a plurality of stored identities based upon at least one from the group including (i) facial print data and (ii) voice print data. The one or more processors are configured to associate the matched image with an icon representative of the one stored identity.

### BACKGROUND

1. Field of the Invention

The present invention is generally directed to videoconferencing. More particularly, the present invention is directed to an architecture for a multisite video conferencing system for matching a user's voice to a corresponding video image.

2. Background Art

Advancements in multimedia videoconferencing technology have significantly reduced the need for business travel to attend meetings. Although nothing can substitute for personal face-to-face interaction in some settings, the latest videoconferencing systems have become the next best thing to physically being there.

Multisite videoconferences, for example, can involve many participants from geographically dispersed business sites. For example, traditional video conferencing systems enable several participants in large conference rooms at different sites to interact via video monitors. These video monitors incorporate the use of two-way video and audio transmissions such that all of the participants from multiple sites of the conference can hear and see each other simultaneously.

When conducting these conferences using these traditional video conferencing systems, however, it can be extremely difficult to determine the identity of a particular speaker at any given time, especially when multiple speakers are talking. This difficulty is multiplied in that only a single audio stream is produced by the multiple participants seated in a single conference room at a particular site.

An even greater challenge with traditional videoconferencing systems is determining the location of the speaker from among many people in the conference room appearing on a particular monitor. For example, when all of the participants of a conference are live in the same room, the human brain's natural sound localization capacity provides the speaker's location. However, with current technologies, video rendering may be multi-screen or even three-dimensional, but audio is one-dimensional, thereby nullifying any possibility of binaural localization.

Traditional videoconferencing systems use a number of different technologies that provide aspects of audio spatialization and facial recognition. For example, voice conferencing with audio spatialization is an existing technology of Vspace, Inc. Video facial recognition and icon marking is an existing technology of Viewdle®, Inc. Another system, known as Polycom CX5000, uses a multi-camera system and a beam-forming audio localizer to lock one of a multitude of panoramic cameras on the active speaker in a video conference.

Although the traditional aforementioned facial recognition and spatialization technologies provide advancements, it can still be difficult to match a speaker's voice with their corresponding video image.

### BRIEF SUMMARY OF THE EMBODIMENTS

What is needed, therefore, are improved methods and systems for matching a speaker's voice with a corresponding video image being displayed on a video monitor.

A fundamental limitation of traditional video conferencing systems is the processing capability of their underlying computer systems. Many of these traditional systems are unable to perform the level of concurrent processing that would be necessary to dynamically and accurately match the speaker's voice with their corresponding video image. For example, a computer system capable of providing this type of concurrent processing should at least be able to simultaneously perform facial recognition, voiceprint recognition, and geometric audio localization. Embodiments of the present invention are enabled by such a computer system.

The present invention, for example, is based upon an overall architecture that exploits the unification of central processing units (CPUs) and graphics processing units (GPUs) in a flexible computing environment (but does not necessarily require such unification). Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner with respect to resources such as conventional CPUs, conventional GPUs, and/or combinations thereof.

Embodiments of the present invention, under certain circumstances, provide a device including one or more processors, wherein the one or more processors are configured to periodically match an image of an individual with one of a plurality of stored identities based upon at least one from the group including (i) facial print data and (ii) voice print data. The one or more processors are configured to associate the matched image with an icon representative of the one stored identity.

Additional features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1 is an illustrative block diagram of a processing system in accordance with embodiments of the present invention.

FIG. 2 is an illustration of a remote video monitor used in a videoconferencing system in accordance with an embodiment of the present invention.

FIG. 3 is a block diagram illustration of the video conferencing system constructed in accordance with embodiments of the present invention.

FIG. 4 is an illustration of a video monitor of used in a sign-in session conducted in accordance with embodiments of the present invention.

FIG. 5 is an illustration of an operation of the video conferencing system of FIG. 3 in accordance with an embodiment of the present invention.

FIG. 6 depicts a flowchart of an exemplary method of practicing an embodiment of the present invention.

### DETAILED DESCRIPTION OF THE EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

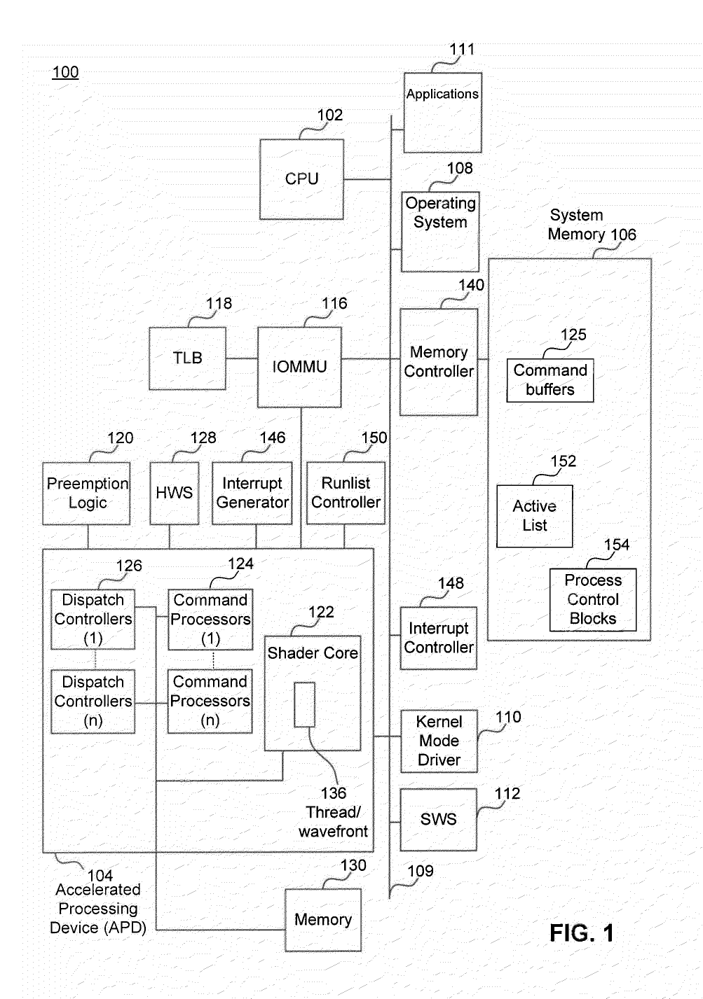

Embodiments of the present invention integrate the use of existing technologies of face recognition, voiceprint recognition, and geometric audio localization with an architecture that exploits CPUs and APDs in a flexible computing environment. Such a computing environment is described in conjunction with the illustration of FIG. 1.

FIG. 1 is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an operating system 108, and a communication infrastructure 109. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. In one example, drivers are hardware-dependent and operating-system-specific. They usually provide the interrupt handling required for any necessary asynchronous time-dependent hardware interface.

CPU 102 can include (not shown) one or more of a control processor, field programmable gate array (FPGA), application specific integrated circuit (ASIC), or digital signal processor (DSP). CPU 102, for example, executes the control logic, including the operating system 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the instruction set architecture (ISA). A command may be executed by a special processor such a dispatch processor, command processor, or network controller. On the other hand, instructions can be considered, for example, a single operation of a processor within a computer architecture. In one example, when using two sets of ISAs, some instructions are used to execute x86 programs and some instructions are used to execute kernels on an APD compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as those that are common in graphics processing.

A work-item is distinguished from other executions within the collection by its global ID and local ID. In one example, a subset of work-items in a workgroup that execute simultaneously together on a SIMD can be referred to as a wavefront 136. The width of a wavefront is a characteristic of the hardware of the compute unit (e.g., SIMD processing core). As referred to herein, a workgroup is a collection of related work-items that execute on a single compute unit. The work-items in the group execute the same kernel and share local memory and work-group barriers.

Within the system 100, APD 104 includes its own memory, such as graphics memory 130 (although memory 130 is not limited to graphics only use). Graphics memory 130 provides a local memory for use during computations in APD 104. Individual compute units (not shown) within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of command processors (CPs) 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and APD. A plurality of command buffers 125 can be maintained with each process scheduled for execution on the APD 104.

CP 124 can be implemented in hardware, firmware, or software, or a combination thereof. In one embodiment, CP 124 is implemented as a reduced instruction set computer (RISC) engine with microcode for implementing logic including scheduling logic.

APD 104 also includes one or “n” number of dispatch controllers (DCs) 126.

In the present application, the term dispatch refers to a command executed by a dispatch controller that uses the context state to initiate the start of the execution of a kernel for a set of work groups on a set of compute units. DC 126 includes logic to initiate workgroups in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

Referring back to the example above, IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 can include (not shown) one or more of a peripheral component interconnect (PCI) bus, extended PCI (PCI-E) bus, advanced microcontroller bus architecture (AMBA) bus, advanced graphics port (AGP), or other such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In some embodiments, based on interrupts generated by an interrupt controller, such as interrupt controller 148, operating system 108 invokes an appropriate interrupt handling routine. For example, upon detecting a page fault interrupt, operating system 108 may invoke an interrupt handler to initiate loading of the relevant page into memory 106 and to update corresponding page tables.

In some embodiments, SWS 112 maintains an active list 152 in memory 106 of processes to be executed on APD 104. SWS 112 also selects a subset of the processes in active list 152 to be managed by HWS 128 in the hardware. Information relevant for running each process on APD 104 is communicated from CPU 102 to APD 104 through process control blocks (PCB) 154.

Processing logic for applications, operating system, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

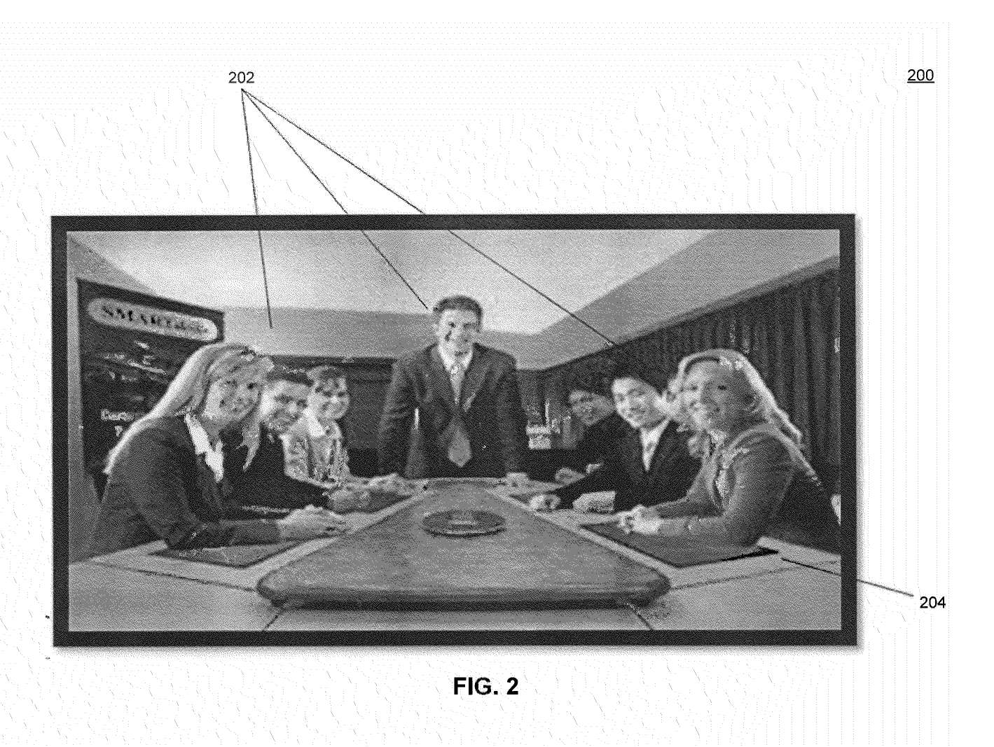

FIG. 2 is an illustration of a remote video monitor 200 used in a multisite video conferencing system in accordance with an embodiment of the present invention. Images of conference participants 202, seated in a conference room 204, are projected onto video monitor 200 for viewing by participants at other videoconference sites.

Embodiments of the present invention use digital signal processing (DSP) software and video overlay technology capable of identifying and overlying the names of participants 202 in the videoconference over their facial images using icon graphics. Additionally, voice recognition technology can identify the voiceprints of the same participants as a means of confirming their identity. As participants sign-in to a meeting, the conference application matches the participants' voice prints to their facial images and icons in the video stream, as explained in greater detail below. Thereafter, these elements are linked for the duration of the conference.

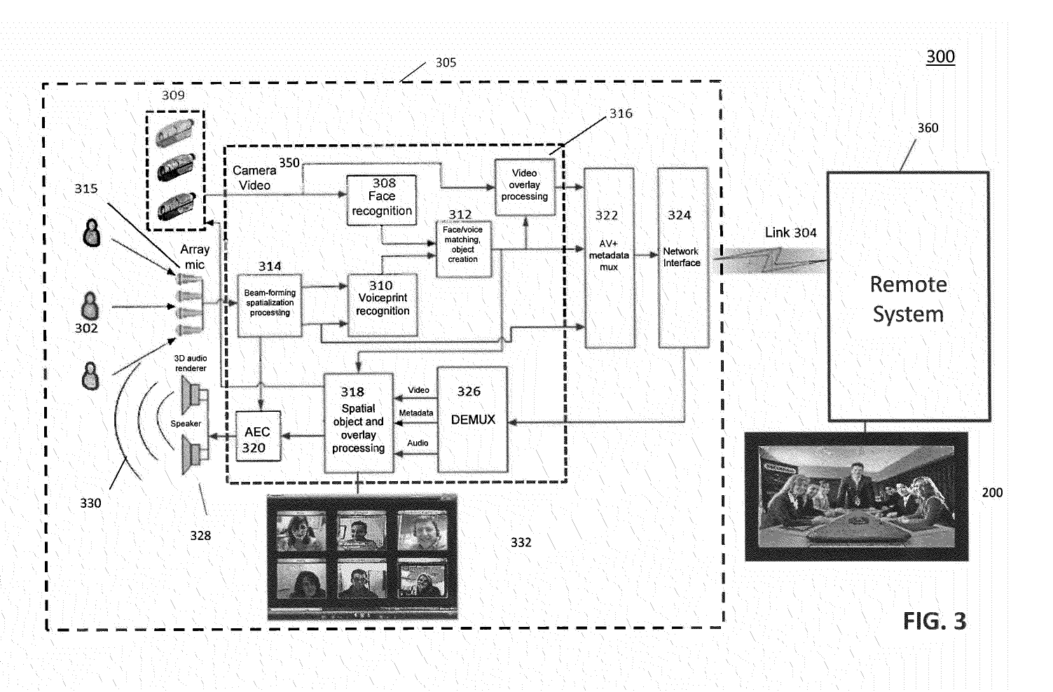

As each participant speaks, their matching icon can be highlighted, and three-dimensional (3-D) audio spatialization rendering techniques can localize each speaker's voice in a sound-field of the listener's environment (e.g., using headphones or speakers) such that the apparent sound source of each speaker matches their video location. This matching can occur even as speaking participants move about conference room 204. Embodiments of the present invention are further described in conjunction with a description of FIG. 3 below.

FIG. 3 is a block diagram illustration of a video conferencing system 300 constructed in accordance with embodiments of the present invention. Video conferencing system 300 includes a local videoconference system 305 that includes a face recognition processor 308, one or more image capture devices 309, a voiceprint recognition processor 310, a face/voice matching processor 312, a beam-forming spatialization processor 314, an array of one or more microphones 315, a video overlay block 316, a spatial object and overlay processor 318, a spatial acoustic echo cancellation processor (AEC) 320, an audio visual metadata multiplexer 322, a network interface 324, a de-multiplexer 326, a three-dimensional audio rendering system 328 that produces object-oriented spatialized audio sound field 330, a local video monitor 332. Video conferencing system 300 also includes a remote video conferencing system 360 and remote monitor 200. As its processing core, system 300 embodies various implementations of computing systems 350 and 360 that can be based on computing system 100 as illustrated in FIG. 1.

Video conferencing system 300 enables local conference participants 302, which consists of one or more participants, to project their images, via link 304, to remote video conferencing system 360 and onto remote video monitor 200 for viewing by remote participants (not shown) located at one or more remote conferencing sites. Facial images of one or more of local participants 302 are processed and recognized using face recognition processor 308. Face recognition processor 308 receives a video stream from image capture device 309 configured to capture and identify facial images of participants 302.

Similarly, a voiceprint recognition processor 310 captures a voiceprint of one or more participants 302. Output signals from face recognition processor 308 and voiceprint recognition processor 310 are processed by face/voice matching processor 312.

Videoconferencing system 300 also includes beam-forming spatialization processor 314 that utilizes beam-forming technology to localize the multiple voice sources of local participants 302. Beam-forming spatialization processor 314 receives voiceprint data captured from multiple voice sources (e.g., from local participants 302) by microphone array 315. The multiple voice sources are encoded as geometric positional audio metadata that is sent in synchronization with data associated with the sound channels. The geometric positional audio metadata, along with data associated with the sound channels, produces spatialized voice streams that are transmitted to processor 310 for voiceprint recognition. More specifically, voiceprint recognition processor 310 generates aural identities of local participants 302.

The voiceprint and face recognition data are then correlated in face/voice matching processor 312, which outputs correlated audio/video (AV) metadata objects for the voice and image of each of local participants 302. In illustrious embodiments of the present invention, a video overlay block 316 uses the objects to overlay icons on facial images of speaking local participants 302. An output of face/voice matching processor 312 is provided as an input to spatial object and overlay processor 318.

Spatial object and overlay processor 318 combines local and remote participant object information to ensure that all objects are presented consistently. Audio of the conference, output from the overly processor 318, is further processed within AEC 320. Processing within AEC 320 prevents audio echoes in spatialized audio sound field 330 from occurring either at the location of local participants 302 or at the location of remote participants (not shown).

During a final stream assembly, the video and audio data streams, metadata, output from face/voice matching processor 312, video overlay processor 316, and spatial object and overlay processor 318, are multiplexed in AV metadata multiplexer 322 and transmitted over network interface 324. Network interface 324 facilitates transmission across link 304 to remote monitor 200 of a remote system, such as remote system 360, which is similar in design to local videoconferencing system 305.

A de-multiplexer 326 receives the audio video stream data, output from network interface 324 produced by remote system 360. The audio video stream data is de-multiplexed and presented as separate video, metadata, and audio inputs to spatial object and overlay processor 318. The metadata portion of the stream is provided, as rendered audio, to AEC 320 and subsequently to 3-D audio renderer 328. The rendered audio stream is used in the generation of video and object-oriented spatialized audio sound field 330 at the source point (e.g., the location of local participants 302). Additionally, the association of the audio and video source into participant objects enables the ability of 3-D renderer 328 to easily remove interfering noise from the playback by playing only the audio that is directly associated with speaking participants and muting all other audio.

Encoding and rendering, as performed in the embodiments, provide a fully-spatialized audio presentation that is consistent with the video portion of the videoconference. In this environment, all the remotely speaking participants are identified graphically in the image displayed on local video monitor 332. Additionally, the remote participant's voices are rendered in a spatialized sound field that is perceptually consistent with the video and graphics associated with the participant's identification. The spatialized sound-field may be rendered by speakers 328 or through headphones worn by participants (not shown).

Additional variations and benefits of the embodiments are also possible. The metadata association of the participant objects with the video images can be based on the geometric audio positions derived from the beam-forming microphone array 315 rather than from voiceprint identification. Additionally, standard monophonic audio telephone-based participants can benefit from the video conferencing system 300. For example, individual audio-only connections can be identified using caller identification (ID) and placed in the videoconference as audio-only participant objects with spatially localized audio, and optionally tagged in the video with graphical icons. Monophonic audio streams benefit through the filtering out of extraneous noise by the participant object association rendering process.

In an embodiment, as an additional benefit the participants with stereo headphones or 3-D audio rendering speakers, but no video, benefit from a spatialized audio experience as the headphones simplify the aural identification of speaking participants. These participants also gain one or more of the additional benefits discussed above.

In other illustrious embodiments of video conferencing system 300, processing components within system 300 can occur sequentially or concurrently across one or more processing cores of APD 104 and/or CPU 102. For example, facial recognition processing can be implemented within one or more processing cores of APD 104 while voiceprint processing can occur within one or more processing cores of CPU 102. Many other face print, voiceprint, and spatial object and overlay processing workload arrangements in the unified CPU/APD processing environment of computing system 100 are within the spirit and scope of the present invention. The computational performance attainable by computing system 100 is an underlying foundation to the seamless integration face print processing, voiceprint processing, and spatial overlay processing to match a speaker's voice with their corresponding video image for display on a video monitor.

In an embodiment, remote system 360 has the same configuration, features, and capabilities as described above with regards to local video conferencing system 305 and would provide remote participants with the same capabilities as to the local participants 302.

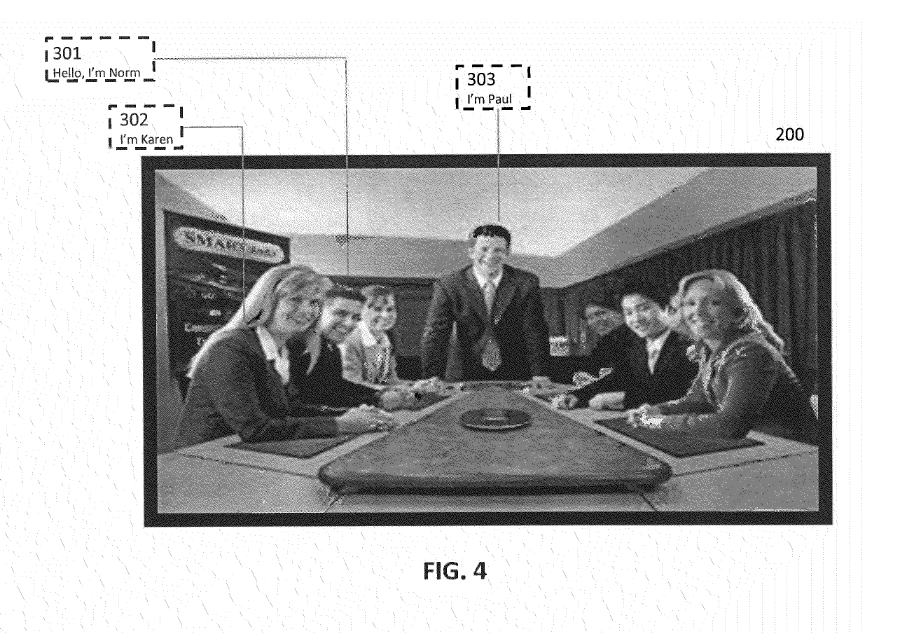

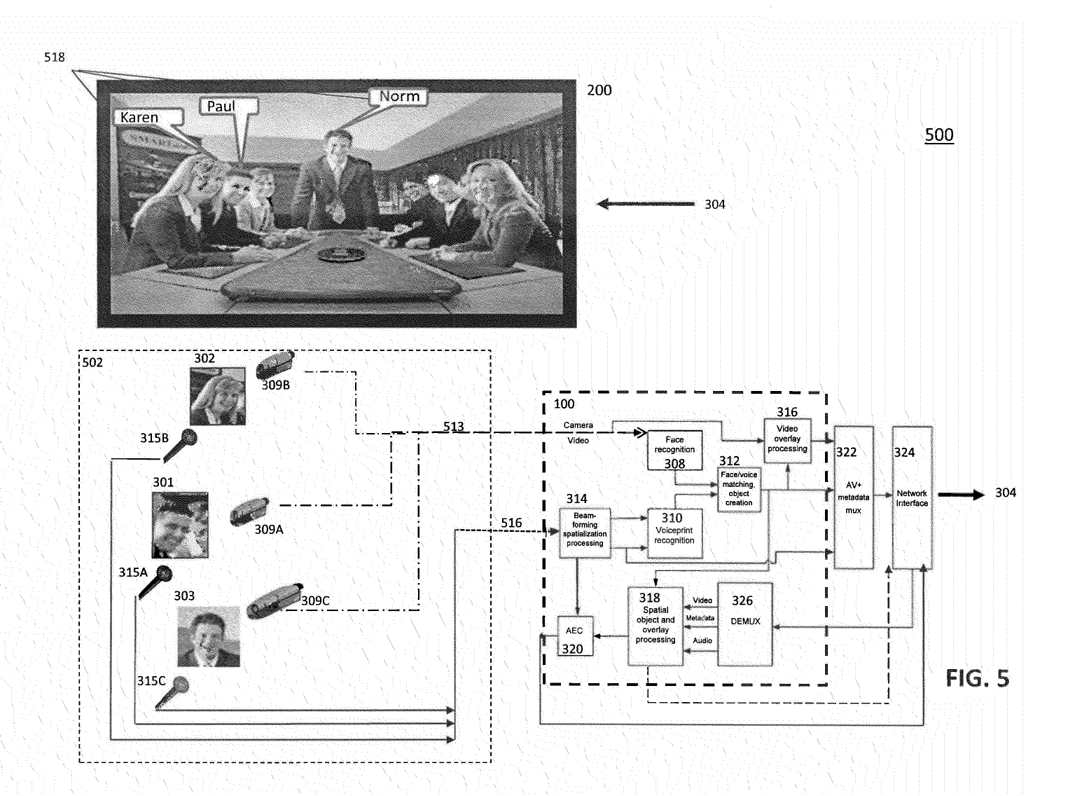

FIG. 4 is an illustration of remote video monitor 200, and of remote videoconferencing system 360, used in a sign-in session in accordance with the embodiments. By way of example, during the start of a videoconference, participants 301, 302, and 303, assembled together in a conference room, can sign in to videoconferencing system 300 with initial introductions. For example, this sign-in session can include simple introductions by one or more participants. As a result, the facial image of respective participants is initially displayed on a video monitor, such as video monitor 200. Additional details of an exemplary sign-in process and a use session are provided in the discussion of FIG. 5 below.

FIG. 5 is an illustration of the operation of the video conferencing system 300 in an example operational scenario, including sign-in and usage, in accordance with the embodiments. In FIG. 5, conference participants 301-303 can be assembled in a conference room 502 for participation in a videoconference 500. During a sign-in session of videoconference 500, facial images of participants 301-303 are respectively captured via individual video cameras 309A-309B (e.g., of video cameras 309). Correspondingly, video cameras 309A-309B provide an output video stream 513, representative of the participants' respective face prints, as an input to face recognition processor 308.

Similarly and simultaneously, voiceprints of participants 301-303 are respectively captured via microphones 315A-315C (e.g., of microphone array 315). Microphones 315A-315C provide an output audio stream 516, representative of the participants' respective voice prints, as an input to beam forming specialization processor 314. Video stream 513 is processed within face recognition processor 308. A recognized facial image is provided as input to face voice matching processor 312. Similarly, audio stream 516 is processed within beam forming specialization processor 314 which provides an input to voiceprint recognition processor 310. Voiceprint recognition processor 310 provides recognized voice data to face voice matching processor 312.

Face voice matching processor 312 compares the recognized facial image in the recognized voice data with stored identities of all of the individual participants 301-303. The comparison matches the identity of one of the participants 301-303 with the recognized facial image and voice data. This process occurs continuously, or periodically, and in real time enabling videoconferencing system 300 to continuously (i.e., over a period of time) capture and match a face print and voiceprint data representative of an image of an individual, to one of a plurality of stored identities.

Video overlay processor 316 associates, or tags, a matched image of an individual representative of stored identity. The matched image in the icon is transmitted via network interface 324, across network link 304, for display on remote video monitor 200. As discussed above, video monitor 200 can be located at one or more remote videoconference sites. The voice print, face print, and spatialization data is used to identify and match the local participants 302, with stored identities of facial and vocal images, and immediately associate graphical icons 518 with the identified facial images. The identified facial images, correlated with the icon(s) 518, are displayed on remote video monitor 200. In the same manner, remote participants, using voiceprint, face print, and spatialization data are identified where graphical icons are associated with the identified facial images and displayed on local video monitor 332 to local participants 301-303.

The graphical icons 518 enable other conference participants to identify one or more of the remote participants, shown on local video monitor 332, whenever the participant speaks during the conference.

With respect to local participants 301-303, the icons 518 are dynamically and autonomously associated with the facial image of an individual participant as they speak, and are displayed on remote video monitor 200. The icon remains associated with the displayed image of the participant, even if the participant becomes non-stationary, or moves around within room 502. For example, if Norm (e.g., participant 303 of FIG. 5) moves from a center of display 200 to and outer edge of the display, icon 518, displaying the participant's identity, will remain associated with the facial image. Once sign-in has been completed, the participant's voice print and face print remain integrated together. This association remains fixed and is displayed on a monitor whenever a participant speaks.

Although in the exemplary videoconference 500 multiple icons are displayed, embodiments of the present invention are configured to only display icons for participants who are actually speaking The videoconferencing system 300 is configured to provide real-time identification and matching of all of the participants speaking. The speaking participants are distinguished from non-speaking participants with the graphical icon 518 being associated with the received voice print and the facial image of the actual speaker.

Although the exemplary videoconference 500 depicts video monitor 200 with a single screen, it can be appreciated that multiple audio and video streams can originate from multiple conference sites. These multiple conference sites can each have a single screen with a single user, a single screen with multiple windows, multiple screens with a single user per screen, multiple screens with multiple users and/or combinations thereof.

In additional embodiments of the present invention, a participant's voiceprint can be used to more accurately track the participant's face print. For example, the spatialization data output from spatial object processor 318 can be used to reliably determine a participant's position to more accurately identify their position and associate that position with a particular face print. This process enables videoconference system 300 to more accurately track movement of participants and maintain correlation between the graphical icon and the voiceprint associated with the displayed facial image.

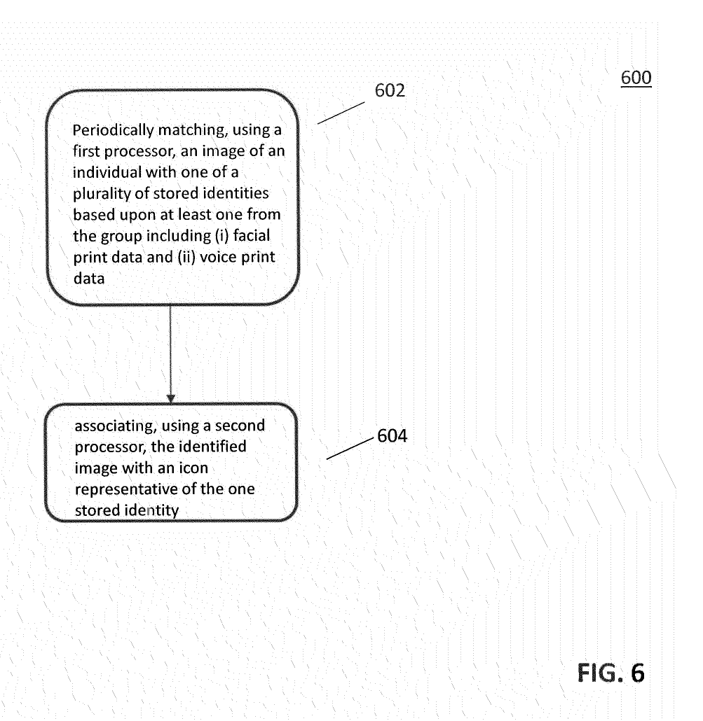

FIG. 6 depicts a flowchart of an exemplary method 600 of practicing an embodiment of the present invention. Method 600 includes operation 602 for periodically matching, using a first processor, an image of an individual with one of a plurality of stored identities based upon at least one from the group including (i) facial print data and (ii) voice print data. In operation 604, the identified image is associated with an icon representative of the one stored identity using a second processor.

In an embodiment where the voiceprint identity confirmation operation 604 is considered as more reliable than the facial print identity determination operation 602, or vice-versa, a weighted voting technique, where the assigned weights are proportional to the estimated accuracies of the operations, may be used to resolve any disagreement that arises regarding the identity determined for a participant by each of the two operations.

For example, if the voiceprint operation identifies a speaker as Paul, while the facial print operation identifies the same speaker as Norm, and the assigned weight for the voiceprint operation is greater than the assigned weight for the facial print operation, the method will identify the speaker as Paul. Moreover, the assigned weights may vary dynamically in proportion to the estimated reliabilities of the identification operations for the given images and sound data that are captured and presented to the operations.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A device, comprising:
one or more processors;
wherein the one or more processors are configured to periodically match an image of an individual with one of a plurality of stored identities based upon at least one from the group including (i) facial print data and (ii) voice print data; and
wherein the one or more processors are configured to associate the matched image with an icon representative of the one stored identity.

2. The device of claim 1, wherein the associating of the identified image with the icon is maintained when the individual is non-stationary.

3. The device of claim 1, wherein the periodically identifying only occurs when the individual is speaking.

4. The device of claim 1, further comprising an interface configured for coupling the device to a videoconferencing system.

5. The device of claim 1, wherein the one or more processors are components within a computing system including an accelerated processing device (APD) configured for unified operation with a central processing unit (CPU).

6. A system, comprising:
a first processor configured to periodically match an image of an individual with one of a plurality of stored identities based upon facial print data; and
a second processor coupled at least indirectly to the first processor and configured to confirm the matching of the image based upon voiceprint data;
wherein the confirmed matched image is associated with an icon representative of the one stored identity.

7. The system of claim 6, wherein the first processor is electrically coupled to a video camera and configured to receive the facial print data as an output therefrom.

8. The system of claim 7, wherein the second processor is electrically coupled to a microphone and configured to receive the voiceprint data as an output therefrom.

9. The system of claim 7, wherein the matching occurs in real time.

10. The system of claim 9, wherein the image of the user is displayed on a video monitor.

11. The system of claim 10, further comprising a third processor configured to continue associating the next image with the icon when the individual is non-stationary.

12. The system of claim 11, wherein the video camera and the video monitor communicate wirelessly.

13. The system of claim 6, wherein the associating occurs only when the individual is speaking.

14. The system of claim 17, wherein the associating occurs autonomously.

15. The system of claim 14, wherein the first and second processors are components within a heterogeneous computing system.

16. The system of claim 15 wherein the heterogeneous computing system includes an accelerated processing device (APD) configured for unified operation with a central processing unit (CPU).

17. A method comprising:
periodically matching, using a first processor, an image of an individual with one of a plurality of stored identities based upon at least one from the group including (i) facial print data and (ii) voice print data; and
associating, using a second processor, the matched image with an icon representative of the one stored identity.

18. The method of claim 17, wherein the associating is maintained when the individual is non-stationary.

19. The method of claim 18, wherein the matching occurs only when the individual is speaking.

20. The method of claim 17, wherein the matching occurs autonomously.

21. The method of claim 17, wherein the matching is devoid of user intervention.

22. A computer readable medium storage device having instructions stored thereon, execution of which, by a computing device, causes the computing device to perform operations comprising:
periodically matching, using a first processor, an image of an individual with one of a plurality of stored identities based upon at least one from the group including (i) facial print data and (ii) voice print data; and
associating, using a second processor, the matched image with an icon representative of the one stored identity.

23. A method comprising:
periodically matching, using a first processor, an image of an individual with one of a plurality of stored identities based upon voice print data; and
determining, using a second processor, a location of the image based upon face print data when the image is non-stationary.

24. The method of claim 23, wherein the voice print data is spatialized.
